(19) United States
(12) Patent Application Publication
(10) Pub. No.: US 2011/0181048 A1
(43) Pub. Date: Jul. 28, 2011

(54) GEAR DRIVEN ENERGY TRANSFER SYSTEM

(76) Inventors: CHRISTOPHER SCOTTI, Gloucester, MA (US); SIMON PRUDENZI, Gloucester, MA (US)

(21) Appl. No.: 12/693,897

(22) Filed: Jan. 26, 2010

(51) Int. Cl. H02K 7/18; H02K 53/00

(52) U.S. Cl. 290/1 C; 415/916

(57) ABSTRACT

A gear driven energy transfer system having a pair of power conversion systems, wherein each system includes an electric drive motor, a gear box, a transmission and a generator to allow for the powering of a plurality of devices connected to the system.

### BACKGROUND OF THE INVENTION

1. Field of the Invention

The present invention relates to the transfer of energy, and more particularly to a gear driven energy transfer system that employs a pair of power conversion systems for the transfer of energy through the variation of gear ratios in each system.

2. Description of the Prior Art

Energy is the ability to do work or to organize or change matter. Furthermore, energy can be transferred from one location to another, for example, as in the sun's energy travels through space to Earth. The two ways that energy can be transferred are through doing work and by heat transfer.

Energy is subject to a strict global conservation law; that is, whenever one measures (or calculates) the total energy of a system of particles whose interactions do not depend explicitly on time, it is found that the total energy of the system always remains constant.

A familiar example is mechanical work. In simple cases this is written as the following equation:

ΔE=W (1)

If there are no other energy-transfer processes involved. Here E is the amount of energy transferred, and W represents the work done on the system. More generally, the energy transfer can be split into two categories:

ΔE=W+Q (2)

Where Q represents the heat flow into the system.

The transfer of energy can take various forms; familiar examples include work, heat flow, and advection, as discussed below. Since energy is strictly conserved and is also locally conserved (wherever it can be defined), it is important to remember that by the definition of energy the transfer of energy between the “system” and adjacent regions is work.

### SUMMARY OF THE INVENTION

It is therefore a primary objective of the invention to provide a gear driven energy transfer system, wherein the system allows for the powering of a plurality of devices connected to the energy transfer system through a variation of gear ratios within the system.

To this end, the present invention provides a gear driven energy transfer system including a pair of power conversion systems, wherein each power conversion system possesses an electric drive motor coupled to a gear box, a transmission which is coupled to the gear box and a generator, whereby the generator of the first power conversion system allows for the operation of the electric drive motor in the second power conversion system by the transfer of energy generated from the first power conversion system, thus enabling a plurality of devices connected to the instant invention to operate.

These and other objects of the present invention will no doubt became obvious to those of ordinary skill in the art after reading the following detailed description of the preferred embodiment, which is illustrated in the various figures and drawings.

There has thus been outlined, rather broadly, the more important features of the gear driven energy transfer system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 is a block diagram of the instant invention illustrating a first power conversion system;

FIG. 2 is a block diagram of the instant invention illustrating a second power conversion system, wherein the second system is disposed to work in conjunction with the first system;

FIG. 3 is a diagrammatic perspective view of a plurality of energy sources disposed to operate the first power conversion system via an electric drive motor.

### DETAILED DESCRIPTION OF THE SEVERAL EMBODIMENTS

In the following detailed description of the several embodiments, a Gear Driven Energy Transfer System 10 is employed for the transfer of energy through a pair of power conversion systems utilizing a variety of gear trains comprising ratios designed to initially increase and subsequently decrease torque to allow for the powering of a plurality of devices connected to the system 10.

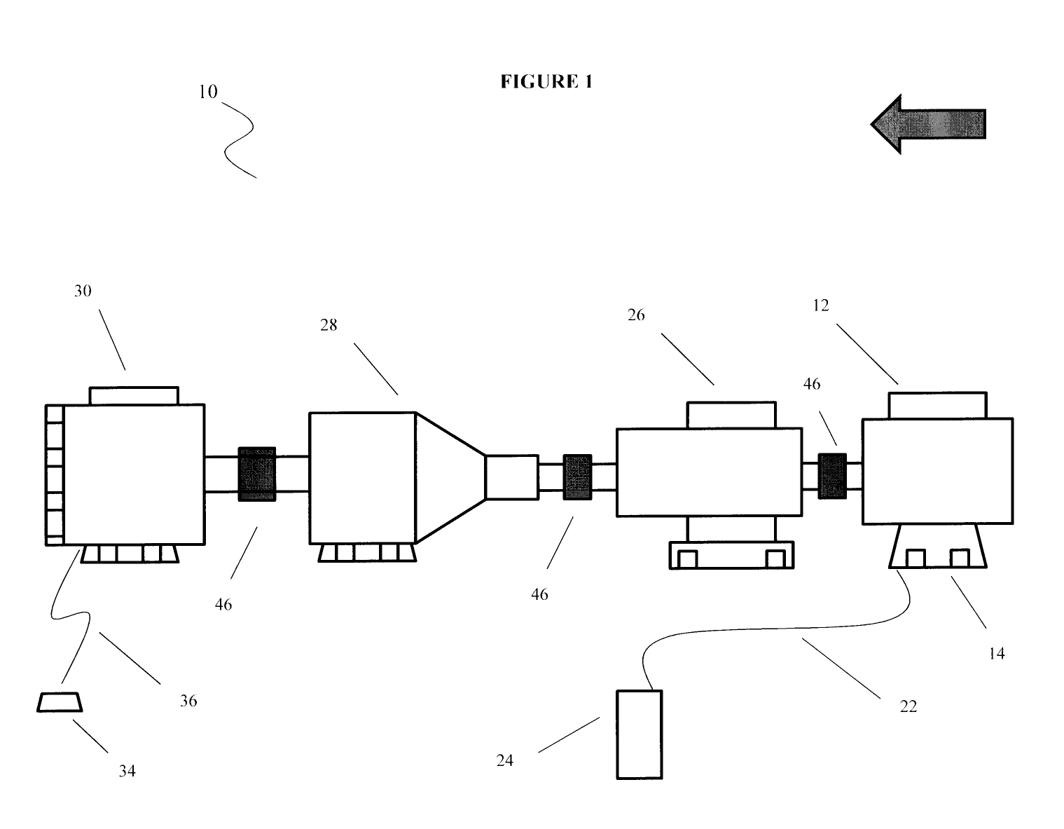

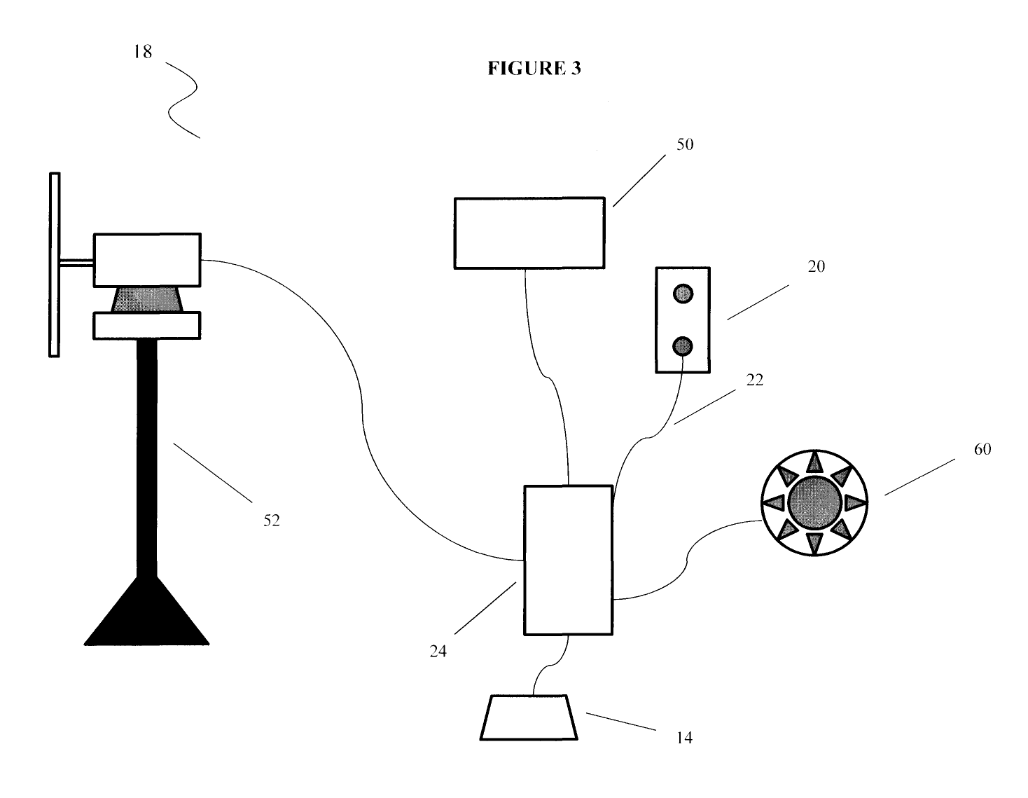

FIG. 1 illustrates the Energy Transfer System 10, wherein the system 10 includes a first power conversion system 12 having an electric drive motor 14 that is disposed to receive power from a plurality of energy sources 18 (see FIG. 3) to allow for the operation of the first conversion system 12. In one preferred embodiment, the electric drive motor 14 of the first conversion system 12 is a two-horsepower, one-phase two hundred forty volt electric drive motor that is capable of producing eight amps of electricity.

In one preferred embodiment, the electric drive motor 14 of the first power conversion system 12 operates with an input of one thousand eight hundred revolutions per minute based on the power supply from the plurality of energy sources 18 described below. In alternate embodiments, the input of the electric drive motor 14 may vary depending on the specific operational needs and uses of the instant invention. The first conversion system 12 further comprises a gear box 26, wherein the gear box 26 is in communication with the electric drive motor 14 via a mechanical coupling 46. In one embodiment the mechanical coupling 46 is a lovejoy coupling, however other functionally equivalent couplings may be utilized as contemplated by those known in the art. In this embodiment, there is a twenty-six to one gear ratio between the shaft input from the electric drive motor 14 and the shaft output from the gear box 26, wherein the change in the gear ratio leads to an increase in torque as there is a step down in the revolutions per minute from approximately one thousand eight hundred rpm's in the electric drive motor 14 to approximately sixty to one hundred rpm's in the gear box 26. Moreover, with the reduction in the speed of the shaft output between the electric drive motor 14 and the gear box 26, there is preferably an increase in torque from approximately ninety foot/pounds seen in the electric drive motor 14 to approximately two hundred seventy foot/pounds seen in the gear box 26.

The first power conversion system 12 of the instant invention further comprises a transmission 28, wherein the transmission is in communication with the gear box 26 via the mechanical coupling 46. The transmission 28 is disposed to increase the speed of the shaft 16 by a twelve to one gear ratio between the gear box 26 and the transmission 28, wherein there is a step up in the revolutions per minute from between sixty to one hundred rpm's in the gear box 26 to approximately one thousand two hundred rpm's in the transmission 28. The increase in revolutions per minute from the gear box 26 to the transmission 28, allows for the transmission 28 to power up a first generator 30, wherein the first generator 30 is in communication with the transmission 28 via the mechanical coupling 46. Furthermore, in one embodiment, the gear box 26 and the transmission 28 are disposed to absorb the friction created by the generator 30 during initial start-up of the system 10 to prevent fuses or breakers from blowing or tripping respectively, within the system 10.

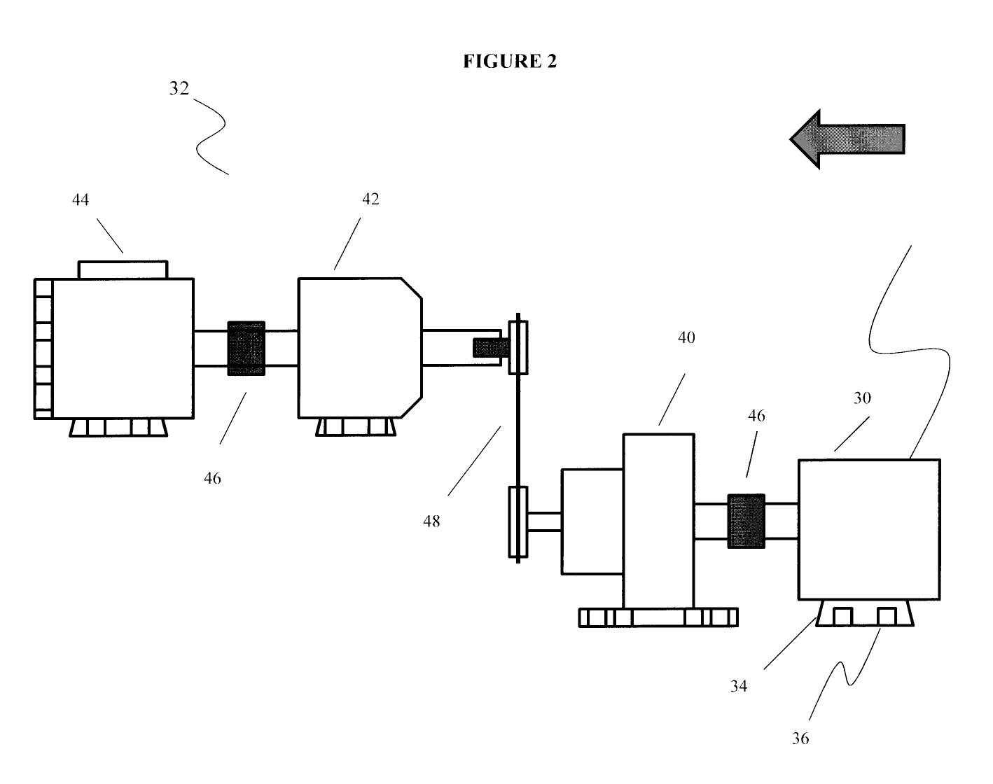

FIG. 2 illustrates a second power conversion system 32, wherein the second conversion system 32 works in conjunction with the first conversion system 12 to transfer energy to a plurality of devices connected to the instant invention 10. In one preferred embodiment, the second power conversion system 32 further comprises a second electric driver motor 34, wherein the first generator 30 is in electrical communication with the second electric drive motor 34. In one embodiment, the second electric drive motor 34 is a ten horsepower, three phase four hundred eighty volt drive motor that is capable of producing twenty amps of electricity. In alternate embodiments, the second electric drive motor 34 is a thirty-six volt, one phase direct current (“DC”) motor; in another alternate embodiment, the second electric drive motor 34 is a seventy-two volt, one phase DC motor. The first generator 34 further comprises a solid state starter 36, wherein the solid state starter is disposed to reduce current from the motor upon starting; in the preferred embodiment, the solid state starter 36 is employed when the second electric drive motor 34 possesses above seven-and-a-half horsepower.

In one preferred embodiment, the second electric drive motor 34 of the second power conversion system 32 operates with an input of one thousand two hundred revolutions per minute based on the power supply from the first generator 30 as described above. It should be readily apparent to those skilled in the art that the actual rpm's and energy production numbers stated hereinabove represent the preferred embodiment of the instant invention, and substitutions with respect to the energy sources and/or electric drive motors will be consistent with those elements known in the art and according to the operational parameters of the instant invention. Furthermore, in alternate embodiments, the input of the second electric drive motor 34 may vary depending on the specific operational needs and uses of the instant invention. The second generator system further comprises a second gear box 40, wherein the second gear box 40 is in communication with the second electric drive motor 34 via the mechanical coupling 46. In this embodiment, there is a four to one gear ratio between the shaft input of the second electric drive motor 34 and the shaft output of the second gear box 40, wherein the change in the gear ratio leads to an increase in torque as there is a step down in the revolutions per minute from approximately one thousand two hundred rpm's in the second electric drive motor 34 to approximately three hundred rpm's in the second gear box 40. Moreover, with the reduction in speed between the second electric drive motor 34 and the second gear box 40, there is preferably an increase in torque from approximately ninety foot/pounds seen in the second electric drive motor 34 to approximately two hundred seventy foot/pounds of torque in the second gear box 40.

The second power conversion system 32 of the instant invention further comprises a second transmission 42, wherein the second transmission 42 is in communication with the second gear box 40 via a connecting belt 48. The second transmission 42 is disposed to increase the speed of the connecting belt by a four to one gear ratio between the input of the second gear box 40 and the output of the second transmission 42, wherein there is a step up in the revolutions per minute from three hundred rpm's from the second gear box 40 to approximately one thousand two hundred rpm's in the second transmission 42. The increase in revolutions per minute from the second gear box 40 to the second transmission 42, allows for the second transmission 42 to power up a second generator 44, for use in a building or residential home, wherein the second generator 44 is in communication with the second transmission 42 via the mechanical coupling 46.

FIG. 3 illustrates the plurality of energy sources 18 disposed to operate the electric drive motor 14 of the first conversion system 12. In one embodiment of the instant invention, the plurality of energy sources 18 is disposed to be electrical communication with a control panel 24, wherein the control panel is in electrical communication with the electric drive motor 14 of the first power conversion system 12. In one embodiment of the instant invention, the electric drive motor 14 receives the necessary input of energy from a city power supply 20 by connecting a power cord 22 as known in the art between the city power supply 20 and the control panel 24.

In alternate embodiments, the city power supply may comprise a one hundred twenty volt/two hundred forty volt outlet, whereby in order to power up the electric drive motor 14 at six amps, requires two hundred forty volts, as compared to power up the electric drive motor 14 at twelve amps, requires one hundred twenty volts. In another alternate embodiment, the instant invention 10 may employ the use of solar power via a plurality of solar panels 50 to power the electric drive motor 14. In yet another alternate embodiment, the instant invention 10 may employ the use of wind power via a plurality of wind turbines 52 to power the electric drive motor 14, wherein the wind turbines may be located on the roof of a building, or other feasible locations as contemplated by those known in the art.

In yet another alternate embodiment, the instant invention may employ the use of battery power 54 as a system back-up in the event that insufficient power is provided by either wind or solar alone, or in combination. In one preferred embodiment, the instant invention will utilize either wind or solar power as a primary power source for powering the electric motor 14 of the first conversion system 12. The use of battery power 54 by the instant invention functions primarily as a back-up power source, and depending on the type and number of batteries employed, may supply power for up to seventy-two hours to the electric drive motor 14. Furthermore, in one preferred embodiment, the control panel 24 as known in the art is provided to regulate the type and amount of each power source that will be utilized to power the electric drive motor at a specific time and day. For example, through a series of relays and sensors, as known in the art of backup power generators the control panel 24 is configured to activate either the city power supply or battery power upon a reading of inadequate power, or a power surge for the electric drive motor 14 by the control panel 24.

Now that the invention has been set forth, an explanation of the use of the instant invention will be put forth, along with further discussion of the advantages of the instant invention.

### Examples

One embodiment of the instant invention features a three horsepower electric drive motor possessing an input of one thousand seven hundred fifty revolutions per minute; the gear ratio from the input of the electric drive motor to the output of the gear box is twenty nine to one, thereby generating an output of sixty revolutions per minute in the gear box. The initial torque see in the electric drive motor is approximately fifteen foot/pounds, and considering the gear ratio provides an increase in torque seen in the gear box of four hundred thirty five foot/pounds; a subsequent increase in the shaft output been the gear box and transmission of sixty-and-a-half to one provides a decreased torque of sixty five foot/pounds in the transmission. As a result of the speed increase and reduction in torque, this provides enough power to run a ten thousand watt generator at nine hundred revolutions per minute.

Some alternate embodiments and various examples of the present invention comprise the following parameters:

1) The driver gear possesses a speed of sixty-eight revolutions per minute (rpm's); a gear ratio between the driver gear and second drive gear of 1.6=108.8 RPM Second Gear Speed.

Gear Teeth=Drive Gear 72 Teeth÷45 Teeth=1.6 Gear Ratio

45 Teeth×1.6 GR.=72 Teeth of Drive Gear.

72 Teeth÷into 1.6 Ratio S.G.D.=45 Teeth.

### 2) 108.8 RPM÷2.3 G Ratio=47 RPM D.G

45 Teeth×2.3R=103.5 Teeth D.E

or

45 Teeth Second Drive×2.4R=108 Teeth D.G

or

45 Teeth Second Drive×2.5R=112.5 Teeth D.G.

3a) Twenty kilowatt generator possessing a speed of one thousand two hundred revolutions per minute having a torque of one hundred twenty five foot/pounds requires a forty-two horsepower engine.
3b) Twenty kilowatt generator possessing a speed of three hundred revolutions per minute having a torque of one hundred twenty five foot/pounds requires a seven-and-a-half horsepower engine, when the system utilizes a six to one gear ratio reduction.
4) Twenty kilowatt generator possessing a speed of one thousand two hundred revolutions per minute possessing a voltage of four thousand one hundred sixty at five amps produces twenty thousand eight hundred watts. Therefore, he higher the voltage the lower the amps required and the less these power it takes to run the generator.
5) Twenty kilowatt generator at twenty thousand volts possessing a speed of one thousand two hundred revolutions per minute with one amp creates twenty thousand watts of power. If you place the twenty thousand watts in a transformer and step down the voltage to four hundred eighty, you will obtain twenty-five amps of electricity in the second generator.
6) Fifty kilowatt generator at twenty thousand volts possessing a speed of either three hundred or six hundred revolutions per minute with two and a half amps would produce fifty thousand watts of power and require a one horsepower electric drive motor if there is a gear reduction reducing the speed to six hundred revolutions per minute.

In summary, the invention describes a gear driven energy transfer system. The invention is characterized by a pair of generator systems, wherein each generator system includes an electric drive motor, a gear box, a transmission and a generator. Each generator system utilizes a variation in gear ratios to reduce the speed of the shaft while simultaneously increasing the torque in each system, thereby allowing for the transfer of energy from the first generator system to the electric drive motor in the second generator system for use in powering a plurality of devices connected to the energy transfer system.

The instant invention is not intended to be restricted to the details of the above described embodiments. It is understood that the embodiments described herein are merely illustrative of the instant invention. Variations in the applications and implementation of the gear driven energy transfer system may be contemplated by one of ordinary skill in the art without limiting the intended scope of the instant invention disclosed herein and as defined by the following claims.

What is claimed is:

1. An energy transfer system comprising:
a first power conversion system, wherein the first conversion system further comprises:
an electric drive motor;
a gear box, wherein the gear box is in communication with the electric drive motor;
a transmission, wherein the transmission is in communication with the gear box;
a first generator, wherein the first generator is in communication with the transmission;
a second power conversion system, wherein the second conversion system is disposed to be in electric communication with the first power conversion system and further comprises:
a second electric drive motor;
a second gear box, wherein the second gear box is in communication with the second electric drive motor;
a second transmission, wherein the second transmission is coupled to the second gear box;
a second generator, wherein the second generator is coupled to the second transmission; and
a plurality of energy sources, wherein the plurality of power sources is disposed to operate the electric drive motor of the first power conversion system.

2. The energy transfer system of claim 1, wherein the electric drive motor is a two-horsepower, one-phase two hundred forty volt capable of producing eight amps of electricity.

3. The energy transfer system of claim 1, wherein the electric drive operates with an input of one thousand eight hundred revolutions per minute from the plurality of energy sources.

4. The energy transfer system of claim 1, wherein the mechanical coupling is a lovejoy coupling.

5. The energy transfer system of claim 1, wherein there is a twenty-six to one gear ratio between the shaft input from the electric drive motor and the shaft output from the gear box.

6. The energy transfer system of claim 5, wherein the gear ratio between the shaft input of the electric drive motor and the shaft output of the gear box results in an increase in torque.

7. The energy transfer system of claim 1, wherein there is a step down in the revolutions per minute from one thousand eight in the electric drive motor to a range of sixty to one hundred in the gear box.

8. The energy transfer system of claim 1, wherein there is an increase in torque from ninety foot/pounds in the electric drive motor to two hundred seventy foot/pounds in the gear box.

9. The energy transfer system of claim 1, wherein there is a twelve to one gear ratio between the shaft input of the gear box and the shaft output of the transmission.

10. The energy transfer system of claim 9, wherein there is a step up in the revolutions per minute from one hundred in the gear box to one thousand two hundred in the transmission.

11. The energy transfer system of claim 1, wherein the plurality of energy sources are selected from the group consisting of wind power, solar power, water power, battery power and city power.

12. The energy transfer system of claim 1, wherein the second electric drive motor is a ten-horsepower, three-phase four hundred eighty volt capable of producing twenty amps of electricity.

13. The energy transfer system of claim 1, wherein the first generator further comprises a solid state starter disposed to reduce current from the electric drive motor upon operation.

14. The energy transfer system of claim 1, wherein the second electric drive motor operates with an input of one thousand two hundred revolutions per minute from the output of the first generator.

15. The energy transfer system of claim 1, wherein there is a four to one gear ratio between the shaft input from the second electric drive motor and the shaft output from the second gear box.

16. The energy transfer system of claim 15, wherein the gear ratio between the shaft input of the electric drive motor and the shaft output of the gear box results in an increase in torque.

17. The energy transfer system of claim 1, wherein there is a step down in the revolutions per minute from one thousand two in the second electric drive motor to a range of three hundred in the second gear box.

18. The energy transfer system of claim 1, wherein there is a step up in the revolutions per minute from three hundred in the second gear box to one thousand two hundred in the second transmission.

19. The energy transfer of claim 1, further comprising a control panel, wherein the control panel is disposed to be in electrical communication with the plurality of energy sources.

20. A method for the prevention of power surges during a system start-up, the steps consisting of:
utilizing at least two transmission mechanisms; and
utilizing at least two reduction gear boxes, wherein a first reduction gear box is in communication with a first transmission, and a second gear box is in communication with a second gear box.
